(19) United States
(12) Patent Application Publication
(10) Pub. No.: US 2019/0327442 A1
(43) Pub. Date: Oct. 24, 2019

(54) DISPLAY APPARATUS AND SIGNAL PROCESSING METHOD THEREOF

(71) Applicant: MStar Semiconductor, Inc., Hsinchu Hsien (TW)

(72) Inventors: Fu-Min LU, Hsinchu Hsien (TW); Chin-Yi HUANG, Hsinchu Hsien (TW); Cheng-Che HSU, Hsinchu Hsien (TW)

(21) Appl. No.: 16/011,711

(22) Filed: Jun. 19, 2018

(30) Foreign Application Priority Data
Apr. 23, 2018 (TW) 107113720

(51) Int. Cl. H04N 5/91; H04N 5/262; G06T 1/20; H04N 21/472; H04L 25/03

(52) U.S. Cl. CPC H04N 5/91; H04N 5/262; H04L 25/03057; H04N 21/47217; G06T 1/20

(57) ABSTRACT

A display apparatus includes a video processor, a graphics processor, a combining circuit, a retrieving circuit and a graphics controller. The video processor process target video information and generates a corresponding video signal. The graphics processor processes graphic data and generates a corresponding graphic signal. When the target video data changes from first video data to second video data, the retrieving circuit retrieves a static picture associated with the first video data and accordingly generates a retrieval result. The graphics controller utilizes the retrieval result as graphic data provided to the graphics processor. The combining circuit combines the graphic signal on the video signal to generate an output video signal.

This application claims the benefit of Taiwan application Serial No. 107113720, filed Apr. 23, 2018, the subject matter of which is incorporated herein by reference.

### BACKGROUND OF THE INVENTION

### Field of the Invention

The invention relates to a communication system, and more particularly to a time-domain decision feedback equalizer in a communication system.

### Description of the Related Art

Television systems are essential and indispensable devices in many households. In the recent years, newly launched television systems are able to not only play programs provided by television service providers, but also connect to the Internet or pluggable external devices and play various types of multimedia files provided from these sources. FIG. 1 shows a schematic diagram of a video playback device of a current television system by taking a situation simultaneously having two pluggable external devices for instance. For example, first video data may be video data of a television program, and second video data may be video data in a multimedia file from the Internet. A selecting circuit 105 is controlled by a video playback command transmitted by a user, and accordingly selects one of the first video data and the second video data as target video data. A video processor 110 parses the target video data to identify specification details of the target video data, e.g., encoding format, resolution or frame rate of the video data, and accordingly performs signal processing processes such as down-conversion, demodulation, de-multiplexing and decoding, thereby generating video signals provided to a display 120.

In practice, video data from different sources is usually in different standards. When a user switches a television system between video data of two different standards, many circuits in the video processor 110 need to be again set according to the standard of the video data to be played. During the process of switching, a current television usually presents a black picture in order to prevent a user from perceiving meaningless transient noise displayed on the screen; that is, the video processor 110 is caused to provide an all-black video frame, and an all-black picture is played on the display 120. Only when new settings are complete, the video processor 110 then again starts to output new video signals to the display 120. An issue of the above approach is that the all-black picture presented during the resetting period may result in undesired user experience.

### SUMMARY OF THE INVENTION

To resolve the above issue, the present invention provides a display apparatus and an image processing method thereof.

According to an embodiment of the present invention, a display apparatus includes a selecting circuit, a video processor, a graphics processor, a combining circuit, a retrieving circuit and a graphics controller. The selecting circuit determines target video data according to a playback command, and generates a retrieval request when the playback command asks to change the target video data from first video data to second video data. The video processor processes the target video data and generates a corresponding video signal. The graphics processor processes graphic data and generates a corresponding graphic signal. The retrieving circuit, in response to the retrieval request, retrieves a static picture associated with the first video data, and accordingly generates a retrieval result. The graphics controller utilizing the retrieval result as the graphic data provided to the graphics processor. The combining circuit combines the graphic signal on the video signal to generate an output video signal.

According to another embodiment of the present invention, an image processing method applied to a display apparatus is provided. The display apparatus includes a video processor and a graphics processor. The video processor generates a video signal corresponding to target video data. The graphics processor generates a graphic signal corresponding to graphic data. The image processing method includes: (a) receiving a playback command asking to change the target video data from first video data to second video data; (b) if the determination result of step (a) is affirmative, retrieving a static picture associated with the first video data and accordingly generating a retrieval result; (c) setting the retrieval result as the graphic data provided to the graphics processor; and (d) combining the graphic signal on the video signal to generate an output video signal.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 (prior art) is a schematic diagram of a video playback device in a current television system;

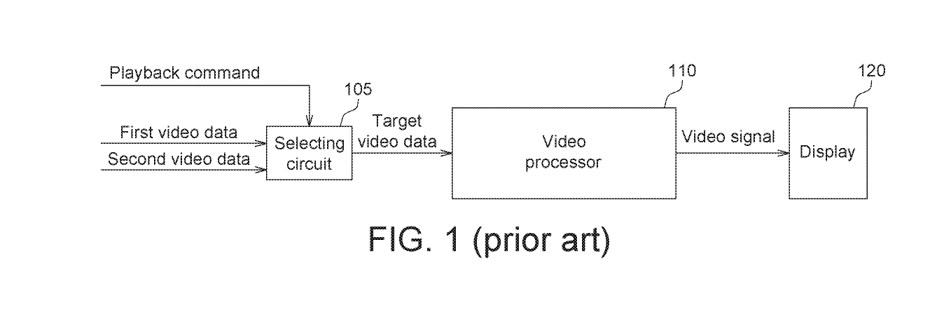

FIG. 2 is a function block diagram of a display apparatus according to an embodiment of the present invention; and

FIG. 3 is a flowchart of an image processing method according to an embodiment of the present invention.

It should be noted that, the drawings of the present invention include functional block diagrams of multiple functional modules related to one another. These drawings are not detailed circuit diagrams, and connection lines therein are for indicating signal flows only. The interactions between the functional elements/or processes are not necessarily achieved through direct electrical connections. Further, functions of the individual elements are not necessarily distributed as depicted in the drawings, and separate blocks are not necessarily implemented by separate electronic elements.

### DETAILED DESCRIPTION OF THE INVENTION

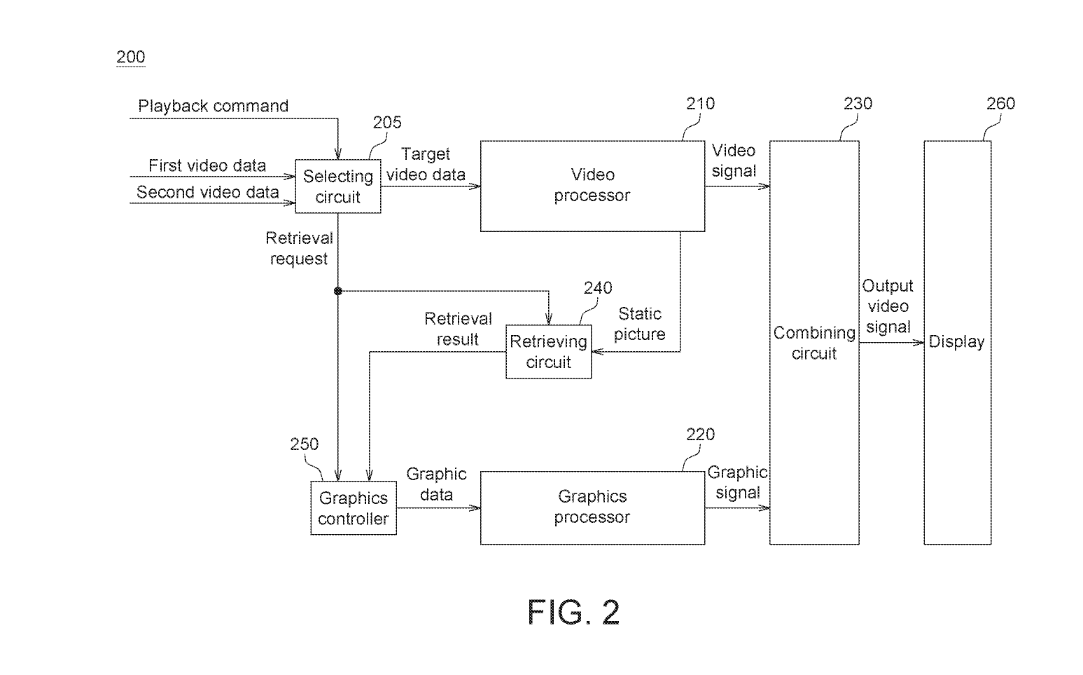

FIG. 2 shows a function block diagram of a display apparatus according to an embodiment of the present invention. A display apparatus 200 includes a selecting circuit 205, a video processor 210, a graphics processor 220, a combining circuit 230, a retrieving circuit 240, a graphics controller 250 and a display 260. In practice, the display apparatus 200 may be a television system or may be other types of video players. Functions and operation details of the circuits are described below.

The display apparatus 200 may be connected to a multiple video data sources, and the selecting circuit 205 selects target video data according to a playback command and provides the selected target video data to the video processor 210. In a practical application, the playback command may be transmitted by a user through a remote controller or a control panel of the display apparatus 200, and the multiple sets of video data may corresponding to, for example but not limited to, programs provided by television service providers, videos read from disks by a disk playback device, multimedia files acquired from the Internet, or multimedia files provided from external devices such as portable drives. The scope of the present invention does not limit the quantity of sources, types of sources and formats of the video data. To keep the description simple and clear, FIG. 2 depicts only two sets of video data (first video data and second video data) as an example.

The video processor 210 receives and processes the target video data and generates a corresponding video signal. More specifically, the video processor 210 may perform one or more image processing processes (for example but not limited to, decoding, demodulation, scaling, and luminance/chrominance adjustment) so as to have the video signal conform to the playback standard of the display 260.

The graphics processor 220 receives and processes graphic data from the graphics controller 250 to generate a corresponding graphic signal. In practice, the graphics processor 220 may be, for example but not limited to, a circuit that renders graphics to provide an on-screen display (OSD) function. For example, the graphic data may be text description or other auxiliary information associated with the target video data, or may be a setting condition (e.g., a screen brightness level or speaker volume) associated with the display apparatus 200. The graphics controller 250 may provide the graphic data to the graphics processor 220 only when needed.

The combining circuit 230 combines the video signal and the graphic signal to generate an output video signal, and provides the output video signal to the display 260 for display. The combining circuit 230 superimposes a graphic layer corresponding to the graphic signal on a graphic layer corresponding to the video signal, such that the graphic layer corresponding to the graphic signal is not masked by the graphic layer corresponding to the video signal; that is, the display priority of the graphic signal is higher than that of the video signal. It should be noted that, the image process technique of combining the two graphic layers is generally known to a person skilled in the art, and is omitted herein.

As previously described, video data from different sources is often in different standards, and when a playback process needs to switch between video data of two different standards, circuits or image processing processes in the video processor 210 may need to be again set. Assume that the target video data selected by the selecting circuit 205 is originally the first video data. When the playback command asks the selecting circuit 205 to change the target video data from the first video data to the second video data, the selecting circuit 205, in addition to changing the target video data outputted, further generates a retrieval request to both the retrieving circuit 240 and the graphics controller 250. In response to the retrieval request, the retrieving circuit 240 retrieves a static picture which is associated with the first video data and then accordingly generates a retrieval result. For example, the static picture may be a latest complete picture, in the video signal outputted from the video processor 210, that corresponds to the first video data, and the retrieving circuit 240 may retrieve the image data of that last complete picture from a memory buffer area (not shown) in the video processor 210. In one embodiment, the retrieving circuit 240 takes the static picture as the retrieval result. In another embodiment, the retrieving circuit 240 generates the retrieval result by performing an image processing process (for example but not limited to, reducing the resolution) on the static picture. The purpose of retrieving the last complete picture corresponding to the video data is to provide a viewer with a complete visual picture, thus resolving the issue of the all-black picture and the desired user experience caused thereby in the prior art.

As shown in FIG. 2, the retrieval result generated by the retrieving circuit 240 is provided to the graphics controller 250. In response to the retrieval request, the graphics controller 250 sets the retrieval result as graphic data provided to the graphics processor 220. As previously described, the display priority of the graphic signal is higher than that of the video signal. Thus, in the above situation, regardless of whether the content outputted by the video processor 210 is an all-black picture or noise at this point, the output video signal outputted by the combining circuit 230 causes the display 260 to play the retrieval result (e.g., the above static picture). In other words, as long as the settings corresponding to the second video data are not complete, the user only sees the above static picture corresponding to the first video data on the display 260.

In one embodiment, after the video processor 210 completes one or more settings corresponding to the second video data and is able to start to normally output the video data corresponding to the second video data, the video processor 210 transmits a completion notification to accordingly notify the graphics controller 250 to stop utilizing the retrieval result as the graphic data provided to the graphics processor 220. In another embodiment, the graphics processor 250 utilizes, within a predetermined period after receiving the retrieval request, the retrieval result as the graphic data provided to the graphics controller 220, and stops providing the retrieval result when the predetermined period ends. For example, assuming it is known that the video processor 210 requires one second at most for setting adjustment each time, the predetermined period may be set as one second.

The above circuits may be implemented by various control/processing platforms, including fixed and programmable logic circuits, e.g., programmable logic gate arrays, application-specific integrated circuits, microcontrollers, microprocessors, and digital signal processors. Further, the circuits may also be designed to complete a task thereof through executing a processor instruction stored in a memory (not shown).

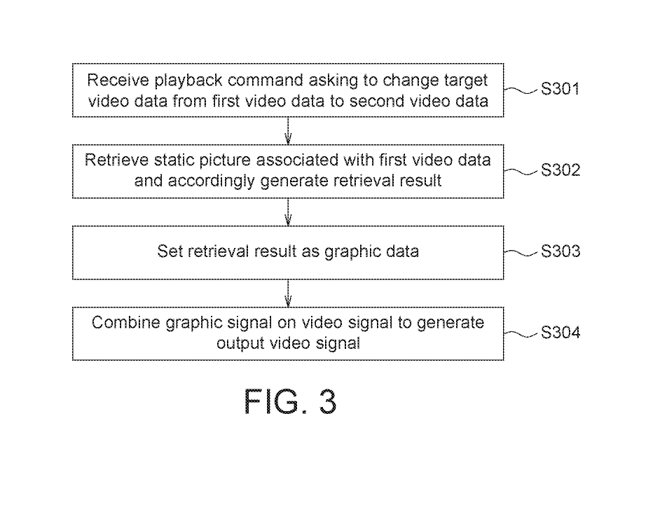

FIG. 3 shows a flowchart of an image processing method applied to a display apparatus according to another embodiment of the present invention. The display apparatus includes a video processor and a graphics processor. The video processor generates a video signal corresponding to target video data. The graphics processor generates a graphic signal corresponding to graphic data. Assume that the target video data is originally first video data. In step S301, a playback command is received, wherein the playback command asks to change the target video data from the first video data to second video data. In step S302, a static picture associated with the first video data is retrieved and a retrieval result is accordingly generated. In step S303, the retrieval result is used as the graphic data provided to the graphics processor. In step S304, the graphic signal corresponding to the retrieval result is combined on the video signal to generate an output video data, wherein a display priority of the graphic signal is higher than that of the video signal.

A person skilled in the art could conceive of applying the operation variations and details in the description associated with the foregoing display apparatus 200 to the image processing method, and associated details are omitted herein.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display apparatus, comprising:
a selecting circuit, determining target video data according to a playback command, and generating a retrieval request when the playback command asks to change the target video data from first video data to second video data;
a video processor, processing the target video data and generating a corresponding video signal;
a graphics processor, processing graphic data and generating a corresponding graphic signal;
a retrieving circuit, in response to the retrieval request, retrieving from the video processor, a static picture associated with the first video data and accordingly generating a retrieval result;
a graphics controller, utilizing the retrieval result as the graphic data provided to the graphics processor; and
a combining circuit, combining the graphic signal on the video signal to generate an output video signal.

2. The display apparatus according to claim 1, wherein the static picture is a latest complete picture of the first video data in the video signal.

3. The display apparatus according to claim 1, wherein the static picture is the retrieval result.

4. The display apparatus according to claim 1, wherein the retrieving circuit performs an image processing process on the static picture to accordingly generate the retrieval result.

5. The display apparatus according to claim 1, wherein, after one or more settings corresponding to the second video data are complete, the video processor transmits a completion notification to have the graphics controller stop utilizing the retrieval result as the graphic data.

6. The display apparatus according to claim 1, wherein the graphics controller, in response to the retrieval request, keeps utilizing the retrieval result as the graphic data for a predetermined period after receiving the retrieval request.

7. An image processing method applied to a display apparatus, the display apparatus comprising a video processor and a graphics processor, the video processor for generating a video signal corresponding to target video data, the graphics processor for generating a graphic signal corresponding to graphic data; the image processing method comprising:
(a) receiving a playback command, which asks to change the target data from first video data to second video data;
(b) retrieving a static picture associated with the first video data and accordingly generating a retrieval result;
(c) setting the retrieval result as the graphic data provided to the graphics processor; and
(d) combining the graphic signal on the video signal to generate an output video signal.

8. The image processing method according to claim 7, wherein the static picture is the retrieval result.

9. The image processing method according to claim 7, wherein step (b) comprises performing an image processing process on the static picture to accordingly generate the retrieval result.

10. The image processing method according to claim 7, further comprising:
terminating step (c) after one or more settings corresponding to the second video data are complete.

11. The image processing method according to claim 7, wherein step (c) comprises utilizing the retrieval result as the graphic data for a predetermined time.

12. The image processing method according to claim 7, wherein step (b) comprises utilizing a latest complete picture of the first video data in the video signal as the static picture.
